(19) United States
(12) Patent Application Publication
(10) Pub. No.: US 2015/0360863 A1
(43) Pub. Date: Dec. 17, 2015

(54) CONTAINER WITH BUILT-IN COMPACTING DEVICE

(71) Applicant: Javier Meza, Fresno, CA (US)

(72) Inventor: Javier Meza, Fresno, CA (US)

(21) Appl. No.: 14/737,502

(22) Filed: Jun. 12, 2015

Related U.S. Application Data
(60) Provisional application No. 62/012,321, filed on Jun. 14, 2014.

(51) Int. Cl. B65F 1/14; B65F 1/16

(52) U.S. Cl. CPC B65F 1/1405; B65F 1/16; B65F 2001/1653

(57) ABSTRACT

The present invention provides improved container for storing and compacting trash and/or recyclables that includes a compartment for receiving trash and/or recyclables, a lid that covers the compartment when in the closed position, a compaction plate that is hingedly attached to the container at or near the opening for compacting trash or recyclables located in the compartment, and an attachment mechanism that detachably connects the compaction plate to the lid for storage when the user is not compacting the trash or recyclables.

### FIELD OF THE INVENTION

The present disclosure relates to improved container systems and compaction devices for household and industrial settings. More specifically, the present disclosure relates to a garbage container system that includes a built-in manual compaction device.

### DISCUSSION OF THE BACKGROUND

Garbage or trash containers are well-known devices used to dispose of various kinds of waste. Handling of waste can be a messy and tedious. Compacting or compressing trash is aids the user by maximizing the amount of trash that can be depositing in the container, making the trash easier to transport (e.g., to a dumpster or other outdoor receptacle), and avoiding the user's need to touch the contents with his hands. In addition to being potentially very unpleasant, it can be unsanitary for the user to contact the waste, and the user could injure himself on sharp waste, such as glass and metal objects. Several types of devices have been developed to reduce the size and amount of waste in a container by compressing or compacting the trash. However, previous trash compactors include complex mechanical, hydraulic or electrical systems, which can be noisy, bulky, expensive, and are prone to malfunction and breakdown.

Manual compactors are also known in the art, but the designs are complex and clumsy (e.g., including external levers, odd shapes, large sizes, etc.). The designs of such devices can be awkward, unwieldy, and visually conspicuous. People generally do not want their trashcans to be bulky and conspicuous, and prefer subtle, inconspicuous waste receptacles. Improved trash compaction devices are needed.

### SUMMARY OF THE INVENTION

The present invention provides improved garbage container system that has an integrated manual compaction device. The compaction device is attached to the container body, within the interior container space and is detachably connected to the lid so that it does not obstruct the deposition of articles into the container during normal use. The compaction device may be detached from the lid by the user when the user desires to compress the articles in the container to create more space in the container or to compress the trash for easier transport. The compaction device may be attached to the container by a rotatable joint (e.g., a hinged connection) that allows the compaction device to be moved downward into interior of the container by the user (e.g., using hand(s) or a foot) to compress articles therein.

The present invention solves the problems that still exist with trash container systems by providing the user with a trash can having a normal and inconspicuous appearance and conventional size, such that it can be stored where any conventional garbage container would be stored. Since the compaction device is connected to the lid of the trash container, and is carefully sized to fit the internal shape of the container, the user has full range of motion with the compaction device without subjecting body parts or clothing to contact with the waste. Without limiting the invention, the compaction device may cover nearly the entire internal cross-sectional area of the container, maximizing amount of trash compaction and minimizing external mess. The present invention provides a clean, easy to use compaction device that is built into the trash container.

The present invention generally provides improved a container for storing and compacting trash and/or recyclables that includes a compartment for receiving trash and/or recyclables, a lid that covers the compartment when in the closed position, a compaction plate that is hingedly attached to the container at or near the opening for compacting trash or recyclables located in the compartment, and an attachment mechanism that detachably connects the compaction plate to the lid for storage when the user is not compacting the trash or recyclables.

The container may be made from sturdy materials (e.g., steel, stainless steel, etc.) that are used for trash receptacles. The compaction device may be made from sturdy materials as well (e.g., steel, stainless steel, etc.). The bottom side of the compaction plate may be coated with a low-friction, non-stick material (e.g., polytetrafluoroethylene, etc.) that helps prevent the accumulation of debris thereon and makes the compaction plate easier to clean.

In one aspect, the present invention relates to improvements in trash and recyclable containers, comprising a body having a compartment therein for receiving the trash or recyclable items; a lid attached to the body, the lid having a perimeter shape that is complementary to an outer perimeter of an opening at the upper end of the body and the lid completely covers the compartment when the lid is closed over the compartment; a compaction plate hingedly attached to the body at the upper end of the body at the opening, the compaction plate having a complementary shape to an interior perimeter of the opening; an attachment mechanism operable to detachably connect the compaction plate to an underside of the lid, such that the compaction plate moves with the lid when the attachment mechanism is engaged, wherein a user of the container may detach the compaction plate from the lid by disengaging the attachment mechanism and compact any trash or recyclable items located within the compartment by applying downward force to the upper surface of the compaction plate. In some implementations, the compaction plate includes at least one vent to allow the movement of air from the compartment to the ambient space. In some implementations, the lid is hingedly attached to the container by a lid hinge joint. In some implementations, the lid hinge joint is coaxial with a plate hinge joint connecting the compaction plate to the container (e.g., the axle(s) of the lid hinge joint is aligned with the axle(s) of the plate hinge joint). In some implementations, the attachment mechanism includes a locking bolt or pin attached to the compaction plate and a receiver in the lid, wherein the compaction plate is attached to and detached from the lid by rotation of the locking bolt or pin. The locking bolt or pin may be a threaded bolt or a pin having a tang protruding therefrom for insertion into the receiver. In some implementations, the attachment mechanism includes a locking bolt or pin attached to the lid and a receiver in the compaction plate, wherein the compaction plate is attached to and detached from the lid by rotation of the locking bolt or pin. In some implementations, the attachment mechanism includes a push-button release latch. In some implementations, the attachment mechanism includes a magnet attached to the compaction plate and a magnetic receiver on the lid. In some implementations, the compaction plate includes a handle on an upper side thereof, and at least a portion of the attachment mechanism is connected to the handle. In some implementations, and without limitation, a maximum width of the opening is immediately adjacent to the hinge joint between the compaction plate and the body of the container, such that the compaction plate can be swung down into said compartment without being obstructed by walls of the body.

In another aspect, the present invention relates to a container comprising a body having a compartment therein and an opening at an upper end of the compartment for access to the interior of the compartment; a compaction plate having a perimeter shape that fits within an interior perimeter of the opening, wherein the compaction plate is hingedly attached to the container at or near the opening of the container; a lid having a shape that covers the opening of the container, wherein the lid is hingedly attached to the container at or near the opening of the container; and an attachment mechanism operable to detachably connect the compaction plate to an underside of the lid, such that the compaction plate moves with the lid when the attachment mechanism is engaged, wherein a user of the container may detach the compaction plate from the lid by disengaging the attachment mechanism and compact any trash or recyclable items located within the compartment by applying downward force to the upper surface of the compaction plate to compact. In some implementations, the compaction plate includes at least one vent to allow the movement of air from the compartment to the ambient space. In some implementations, the lid and the compaction plate are hingedly attached to the container by coaxial hinge joints (e.g., the axle(s) of the lid hinge joint is aligned with the axle(s) of the plate hinge joint). In some implementations, the attachment mechanism includes a locking bolt or pin attached to the compaction plate and a receiver in the lid, wherein the compaction plate is attached to and detached from the lid by rotation of the locking bolt or pin. In some implementations, the attachment mechanism includes a locking bolt or pin attached to the lid and a receiver in the compaction plate, wherein the compaction plate is attached to and detached from the lid by rotation of the locking bolt or pin. In some implementations, the attachment mechanism includes a push-button release latch. In some implementations, the attachment mechanism includes a magnet attached to the compaction plate and a magnetic receiver on the lid. In some implementations, and without limitation, a maximum width of the opening is immediately adjacent to the hinge joint between the compaction plate and the body of the container, such that the compaction plate can be swung down into said compartment without being obstructed by walls of the body.

In a further aspect, the present invention relates to a container for storing for holding trash or recyclable items comprising a body having a compartment therein for receiving the trash or recyclable items and an opening at an upper end of the body for accessing the compartment; a lid hingedly attached to the body at the upper end of the body, the lid having a perimeter shape that is complementary to an outer perimeter of the opening and the lid completely covers the opening when the lid is closed over the compartment; a compaction plate hingedly attached to the body at the upper end of the body at the opening, the compaction plate having a complementary shape to an interior perimeter of the opening, wherein the compaction plate includes a handle on an upper surface thereof; and an attachment mechanism operable to detachably connect the compaction plate to an underside of the lid comprising a locking bolt or pin and a receiver, such that the compaction plate moves with the lid when the attachment mechanism is engaged, wherein a user of the container may detach the compaction plate from the lid by disengaging the attachment mechanism and compact any trash or recyclable items located within the compartment by applying downward force to the upper surface of the compaction plate, and at least a portion of the attachment mechanism is connected to the handle. In some implementations, the lid and the compaction plate are hingedly attached to the container by coaxial hinge joints (e.g., the axle(s) of the lid hinge joint is aligned with the axle(s) of the plate hinge joint). In some implementations, and without limitation, a maximum width of the opening is immediately adjacent to the hinge joint between the compaction plate and the body of the container, such that the compaction plate can be swung down into said compartment without being obstructed by walls of the body.

In some embodiments, and without limitation, the compaction plate may have a shape that is different from the opening of the container and/or a smaller area than the opening of the container. In such embodiments, the container body may taper from the opening down to the base without obstructing the movement of the compaction plate down through the opening to compact the trash. In other embodiments, and without limitation, the container body may taper from a point below the reach of the compaction plate when it rotates into the opening of the container, such that the tapering of the container does not obstruct the movement of the compaction plate.

It is an object of the present invention to provide a container having a compaction device that is built into the trash container and provides a clean, easy means to compact trash or recyclables therein.

It is also an object of the present invention to provide a trash can having a compaction device that is attached to the container body, within the interior container space and is detachably connected to the lid so that it does not obstruct the deposition of articles into the container during normal use.

It is also an object of the present invention to provide a compaction device attached to a container by a rotatable joint (e.g., a hinged connection) that allows the compaction device to be moved downward into interior of the container by the user (e.g., using hand(s) or a foot to compress articles therein.

It is also an object of the present invention to provide a trash container having a normal and inconspicuous appearance and conventional size, such that it can be stored where any conventional garbage container would be stored.

It is also an object of the present invention to provide a container having a compaction device that is carefully sized to fit the internal shape of the container to allow the compaction device to move in and out of the container without being obstructed by the walls of the container or other structures of the container.

It is also an object of the present invention to provide a container having a compaction device that allows the user to compress trash or recyclables in the container without subjecting body parts or clothing to contact with the waste.

Additional aspects and objects of the invention will be apparent from the detailed descriptions and the claims herein.

### BRIEF DESCRIPTION OF THE DRAWINGS

FIG. 1 shows a frontal view of a container according to an embodiment of the present invention.

FIG. 2 shows a perspective view of a container according to an embodiment of the present invention, in which the lid has been rotated on its hinge joint above the opening to expose the interior compartment and the attachment mechanism has been disengaged allowing the compaction plate to rotate on its hinge joint away from the lid and toward the opening.

FIG. 3 shows a perspective view of a container according to another embodiment of the present invention, in which the lid has been rotated on its hinge joint above the opening to expose the interior compartment and the attachment mechanism has been disengaged allowing the compaction plate to rotate on its hinge joint away from the lid and toward the opening.

FIG. 4(a) shows a perspective view of a container according to another embodiment of the present invention, in which the lid has been rotated on its hinge joint above the opening to expose the interior compartment and the attachment mechanism has been disengaged allowing the compaction plate to rotate on its hinge joint away from the lid and toward the opening.

FIG. 4(b) shows a plan view of the upper surface of a lid of a container according to an embodiment of the present invention.

FIG. 5(a) shows a perspective view of a container according to another embodiment of the present invention, in which the lid has been rotated on its hinge joint above the opening to expose the interior compartment and the attachment mechanism has been disengaged allowing the compaction plate to rotate on its hinge joint away from the lid and toward the opening.

FIG. 5(b) shows a plan view of the upper surface of a lid of a container according to an embodiment of the present invention.

FIG. 6 shows a perspective view of a container according to another embodiment of the present invention, in which the lid has been rotated on its hinge joint above the opening to expose the interior compartment and the attachment mechanism has been disengaged allowing the compaction plate to rotate on its hinge joint away from the lid and toward the opening.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. However, it will be apparent to one skilled in the art that the present invention may be practiced without these specific details.

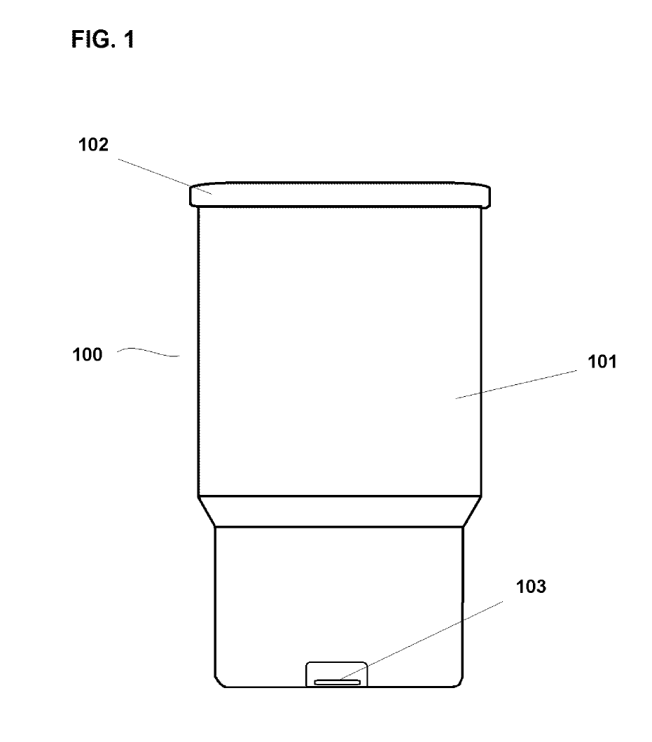

Referring to the drawings wherein like reference characters designate like or corresponding parts throughout the several views, and referring particularly to FIGS. 1-6, it is seen that the present invention includes various embodiments of a container for trash or recyclables having a built-in compaction device.

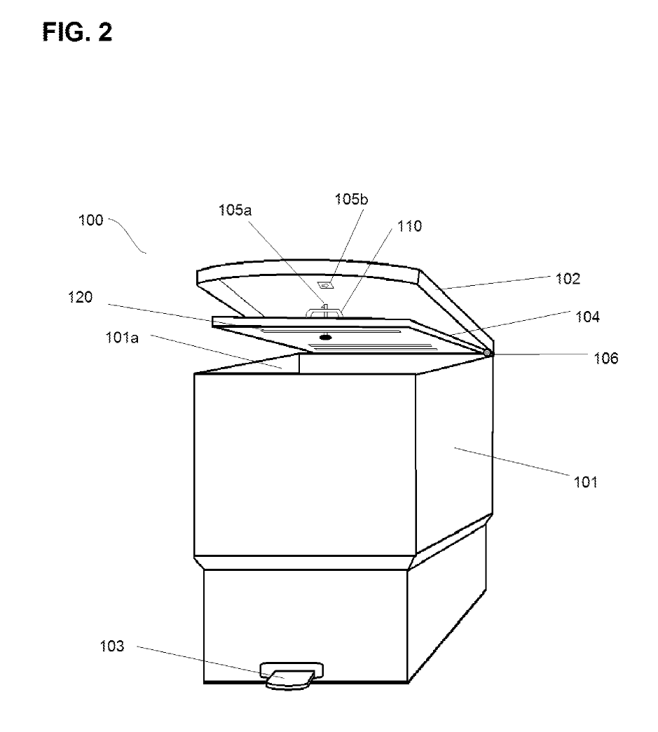

Without limiting the invention, FIG. 1 shows an exemplary container 100. The container 100 includes a body 101 having an open interior compartment 101a, a lid 102, and a pedal mechanism 103 for lifting the lid 102. FIG. 2 provides a perspective view of the container 100 with the lid 102 opened to reveal the compaction plate 104. Without limiting the invention, the container may have a rectangular or rounded rectangular cross-sectional shape as shown in the figures. In other embodiments, the container may have a different shape that allows for the use of a compaction device that is hingedly attached to the container (e.g., a shape that narrows from the point of hinged attachment of the compaction device, such as a shape that tapers away from the hinged joint [e.g., a triangular shape, hemi-ellipsoid, etc.] to allow a complementarily shaped compaction device to swing down into the body of the container). In some embodiments, and without limitation, the container shape may taper or partially taper along the vertical dimension from the opening of the container to the base of the container, such that the opening is wider than all or a portion of the compartment so that compacted, dense trash may be more easily removed from the container.

Both the lid and the compaction plate may be attached to the container by hinge joints that are placed and articulated such that the lid and compaction plate may be raised smoothly from the container when they are connected to each other. For example, and without limitation, the lid 102 and the compaction plate 104 may be hingedly attached to the container 100 by coaxial hinge joints 106. The compaction plate 104 may optionally include vents 120 therein to allow air to pass through the compaction plate 104 as it is used to compress trash or recyclables in the compartment of the container.

The compaction plate 104 may be detachably connected to the lid by an attachment mechanism, which includes a locking bolt 105a (e.g., a pin with a tang thereoin, a wing bolt, etc.), a locking bolt receiver 105b (e.g., a complementary receiver). To attach the compaction plate 104 to the lid 102 during regular use, the locking bolt 105a may be inserted into the receiver 105b. For example, and without limitation, the locking bolt may have a tang thereon that is aligned with a complementary slot in the receiver, and when inserted into the receiver, the locking bolt may be turned (e.g., 90°) to allow the tang to catch in the receiver and hold the compaction plate to the lid. In other implementations, and without limitation, the locking bolt may have male threading and the receiver may be a port having matching female threading into which the bolt maybe screwed.

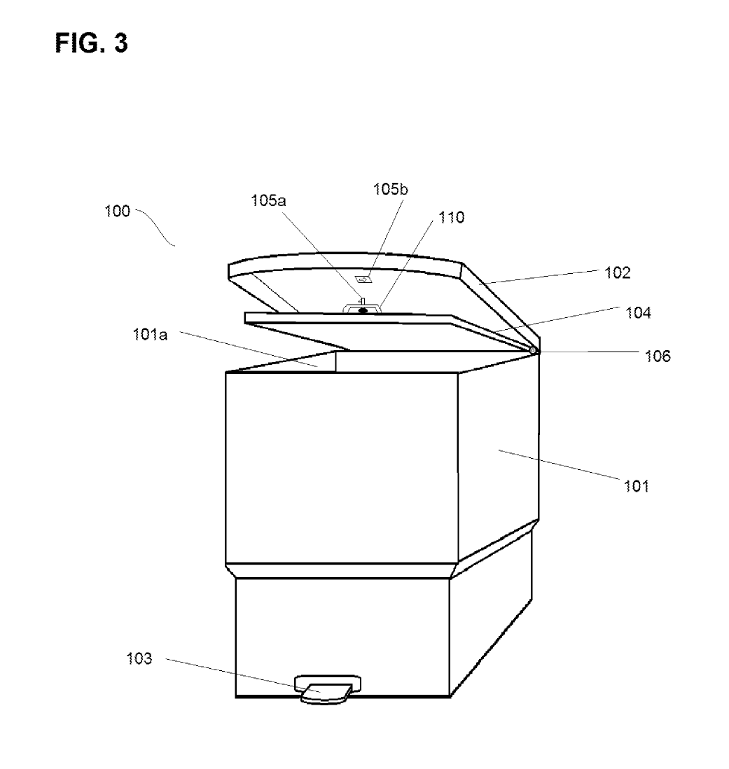

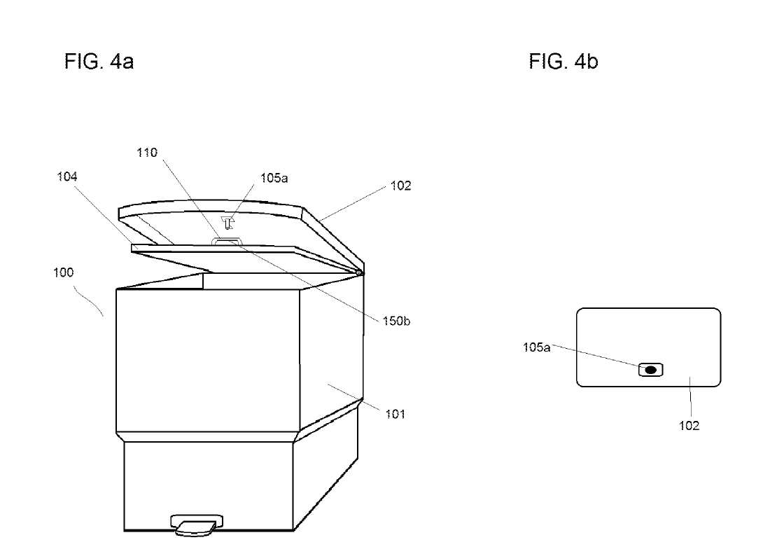

The container 100 may also include a handle 110 for manipulating the position of the compaction plate when it is detached from the lid 102. In some implementations and without limitation, the bolt 105a may be rotatably attached to the handle and the compaction plate directly. In other implementations, and without limitation, the bolt may be rotatably attached to the handle with no direct connection to the compaction plate 104 (see FIG. 3). In still further implementations, and without limitation, the bolt may be rotatably attached to the lid 102 and a threaded receiver may be formed in the handle 110 or the upper surface of the compaction plate 104 (see FIGS. 4a and 4b).

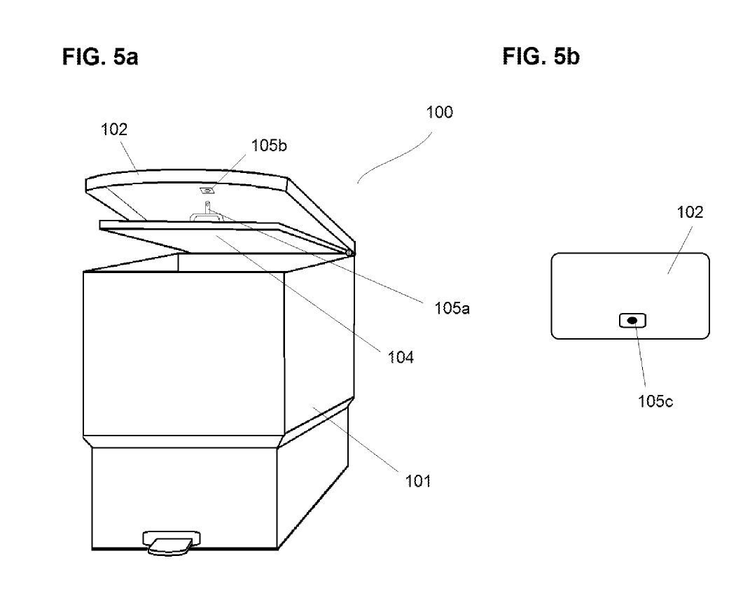

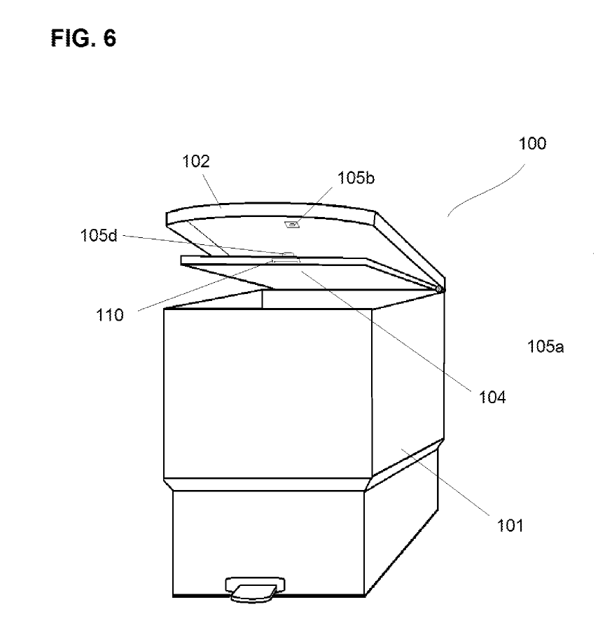

Other implementations may use other types of connection devices. Without limiting the invention, FIGS. 5a-5b show an implementation in which the attachment mechanism is a spring latch that can be disengaged by pushing a button. The attachment mechanism includes a latch bolt 105a having a notch therein and a bolt receiver 105b that may include a spring loaded latch or awl that catches the notch on the latch bolt 105a when the latch bolt 105a is inserted into the receiver 105b. The spring loaded latch or awl may be disengaged from the latch bolt 105a when the release button 105c is depressed. In another implementation, and without limitation, the attachment mechanism may be a magnetic clasp that includes a magnet and a magnetic receiver. For example, and without limitation, FIG. 6 shows an implementation in which a magnet 105d is positioned on the compaction plate 104 and a magnetic receiver 105b (e.g., a plate of magnetic material) is positioned on the underside of the lid 102. The magnetic attraction between the magnet 104a and the magnetic receiver 105b may hold the compaction plate 104 and the lid 102 together until the user applies force to separate them. In such implementations, the handle 110 may be placed along the perimeter of the compaction plate 104 on an opposite side of the compaction plate from the hinge joint 106, such that the user can grasp the handle 110 and pry the compaction plate 104 away from the lid 102. Other embodiments may use different attachment mechanisms. The examples provided herein are only for illustrative purposes and the present invention is not limited to those specific examples.

The present invention provides a container that includes a built-in, manual compaction device that is easy to deploy and use. It is to be understood that here are several variations in the thermally insulative container that provide additional benefits, as disclosed above. It should also be understood that the foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed:

1. A container for storing for holding trash or recyclable items, comprising:
a. a body having a compartment therein for receiving said trash or recyclable items;
b. a lid attached to said body, said lid having a perimeter shape that is complementary to an outer perimeter of an opening at the upper end of said body and said lid completely covers said compartment when said lid is closed over said compartment;
c. a compaction plate hingedly attached to said body at said upper end of said body at said opening, said compaction plate having a complementary shape to an interior perimeter of said opening;
d. an attachment mechanism operable to detachably connect said compaction plate to an underside of said lid, such that said compaction plate moves with said lid when said attachment mechanism is engaged, wherein a user of said container may detach said compaction plate from said lid by disengaging said attachment mechanism and compact any trash or recyclable items located within said compartment by applying downward force to the upper surface of said compaction plate.

2. The container of claim 1, wherein said compaction plate includes at least one vent to allow the movement of air from the compartment to the ambient space.

3. The container of claim 1, wherein said lid is hingedly attached to said container by a lid hinge joint.

4. The container of claim 3, wherein said lid hinge joint is coaxial with a plate hinge joint connecting said compaction plate to said container.

5. The container of claim 1, wherein said attachment mechanism includes a locking bolt attached to said compaction plate and a locking bolt receiver in said lid, wherein said compaction plate is attached to and detached from said lid by rotation of said locking bolt.

6. The container of claim 1, wherein said attachment mechanism includes a locking bolt attached to said lid and a locking bolt receiver in said compaction plate, wherein said compaction plate is attached to and detached from said lid by rotation of said locking bolt.

7. The container of claim 1, wherein said attachment mechanism includes a push-button release latch.

8. The container of claim 1, wherein said attachment mechanism includes a magnet attached to said compaction plate and a magnetic receiver on said lid.

9. The container of claim 1, wherein said compaction plate includes a handle on an upper side thereof, and at least a portion of said attachment mechanism is connected to said handle.

10. A container, comprising:
a. a body having a compartment therein and an opening at an upper end of said compartment for access to the interior of the compartment;
b. a compaction plate having a perimeter shape that fits within an interior perimeter of said opening, wherein said compaction plate is hingedly attached to said container at or near said opening of said container;
c. a lid having a shape that covers said opening of said container, wherein said lid is hingedly attached to said container at or near said opening of said container; and
d. an attachment mechanism operable to detachably connect said compaction plate to an underside of said lid, such that said compaction plate moves with said lid when said attachment mechanism is engaged, wherein a user of said container may detach said compaction plate from said lid by disengaging said attachment mechanism and compact any trash or recyclable items located within said compartment by applying downward force to the upper surface of said compaction plate to compact.

11. The container of claim 10, wherein said compaction plate includes at least one vent to allow the movement of air from the compartment to the ambient space.

12. The container of claim 10, wherein said lid and said compaction plate are hingedly attached to said container by coaxial hinge joints.

13. The container of claim 10, wherein said attachment mechanism includes a locking bolt attached to said compaction plate and a locking bolt receiver in said lid, wherein said compaction plate is attached to and detached from said lid by rotation of said locking bolt.

14. The container of claim 10, wherein said attachment mechanism includes a locking bolt attached to said lid and a locking bolt receiver in said compaction plate, wherein said compaction plate is attached to and detached from said lid by rotation of said locking bolt.

15. The container of claim 10, wherein said attachment mechanism includes a push-button release latch.

16. The container of claim 10, wherein said attachment mechanism includes a magnet attached to said compaction plate and a magnetic receiver on said lid.

17. A container for storing for holding trash or recyclable items, comprising:
a. a body having a compartment therein for receiving said trash or recyclable items and an opening at an upper end of said body for accessing said compartment;
b. a lid hingedly attached to said body at said upper end of said body, said lid having a perimeter shape that is complementary to an outer perimeter of said opening and said lid completely covers said opening when said lid is closed over said compartment;
c. a compaction plate hingedly attached to said body at said upper end of said body at said opening, said compaction plate having a complementary shape to an interior perimeter of said opening, wherein said compaction plate includes a handle on an upper surface thereof; and
d. an attachment mechanism operable to detachably connect said compaction plate to an underside of said lid comprising a locking bolt and a locking bolt receiver, such that said compaction plate moves with said lid when said attachment mechanism is engaged, wherein a user of said container may detach said compaction plate from said lid by disengaging said attachment mechanism and compact any trash or recyclable items located within said compartment by applying downward force to the upper surface of said compaction plate, and at least a portion of said attachment mechanism is connected to said handle.

18. The container of claim 17, wherein said lid and said compaction plate are hingedly attached to said container by coaxial hinge joints.

19. The container of claim 17, wherein said compaction plate includes at least one vent to allow the movement of air from the compartment to the ambient space.

20. The container of claim 17, wherein a maximum width of said opening is immediately adjacent to a hinge joint between said compaction plate and said body, such that said compaction plate can be swung down into said compartment without being obstructed by walls of said body.
